(19) United States
(12) Patent Application Publication
(10) Pub. No.: US 2007/0071645 A1
(43) Pub. Date: Mar. 29, 2007

(54) Biochemical reaction apparatus with refrigeration part

(75) Inventor: Yoshimasa Araki, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/521,396

(22) Filed: Sep. 15, 2006

(30) Foreign Application Priority Data
Sep. 27, 2005 (JP) 2005-280096

(51) Int. Cl. G01N 35/00

(52) U.S. Cl. 422/65

(57) ABSTRACT

There is provided a biochemical reaction apparatus which can prevent contamination in a container having a reagent injected thereinto due to the invading of liquid droplets, dusts or the like from the outside into the container. Further, there is provided a biochemical reaction apparatus in which the refrigeration part can be hermetically sealed by an easy structure and even after the container is transported to a reaction part, the refrigeration part can be also hermetically sealed by the easy structure. The biochemical reaction apparatus includes: a reaction part, a refrigeration part for refrigerating a liquid supplied to the reaction part, a case member for covering the reaction part and the refrigeration part, and a transporting part allowing direct access from the outside of the case member to the inside of the refrigeration part.

### BACKGROUND OF THE INVENTION

1. Field of the Invention

The present invention relates to a biochemical reaction apparatus with a refrigeration part for refrigerating a container having a reagent injected thereinto. The present invention also relates to a method of agitating air in a refrigeration part of a biochemical reaction apparatus.

2. Description of the Related Art

In a biochemical reaction apparatus, depending on a reagent used in the biochemical reaction apparatus, it may be necessary to store the reagent at a low temperature in order to prevent degradation of the reagent. In particular, enzymes which are important in a biochemical reaction may be degraded at room temperature and may become unusable in the biochemical reaction.

As a conventional biochemical reaction apparatus with a refrigeration chamber, one having a refrigeration chamber, a dispensing device, a heater, a detector, and the like is known (e.g., Japanese Patent Application Laid-open No. H07-107999). Such the reaction apparatus has the refrigeration chamber provided therein for storing a sample and a reagent in a container. By placing in the heater of the reaction apparatus the container having the sample and the reagent stored therein, the sample and the reagent in the container can be held at an arbitrary temperature for an arbitrary period of time to control an enzyme reaction and a biochemical reaction which occur in the reaction apparatus. The container is structured so that the container can be transported with a transporting machine by being lifted to the refrigeration chamber, the dispensing device, the heater, and the detector.

As described above, the conventional biochemical reaction apparatus has such a structure that the container having a reagent injected thereinto is moved from a refrigeration part to a reaction part by the transporting machine. In Japanese Patent Application Laid-open No. H07-107999, the transporting machine is a very ordinary robot arm used in an automatic assembly line or the like. However, in order to realize a more simplified reaction apparatus and to reduce costs, it is necessary to further improve the structure.

Further, it is desired to prevent contamination in the biochemical reaction apparatus due to the invading of liquid droplets, dusts or the like from the outside of the reaction apparatus into the container having the reagent injected thereinto. There is also a necessity that air in the refrigeration part be agitated. However, since installation of an agitator does not satisfy a demand for the simplified reaction apparatus and reduction in costs, a solution for the problem is desired.

### SUMMARY OF THE INVENTION

Accordingly, an object of the present invention is to provide a reaction apparatus which can prevent contamination due to the invading of liquid droplets, dusts or the like from the outside of the reaction apparatus.

Another object of the present invention is to provide a simplified reaction apparatus which can reduce costs.

According to the present invention, a biochemical reaction apparatus includes: a reaction part; a refrigeration part for refrigerating a liquid supplied to the reaction part; a case member for covering the reaction part and the refrigeration part; and a transporting part for allowing a direct access from the outside of the case member to the inside of the refrigeration part.

Further, according to the present invention, another biochemical reaction apparatus includes: a reaction part; a refrigeration part for refrigerating a liquid supplied to the reaction part; a case member for covering the reaction part and the refrigeration part; a carriage for transporting the liquid in the refrigeration part to the reaction part; a transporting mechanism for transporting the carriage; a refrigeration part case member for partitioning a space formed by the reaction part and a space formed by the refrigeration part in the case member; an opening formed in the refrigeration part case member through which a body of the carriage can pass; and a hermetic seal part provided on the carriage for hermetically sealing the opening.

Further features of the present invention will become apparent from the following description of exemplary embodiments with reference to the attached drawings.

### BRIEF DESCRIPTION OF THE DRAWINGS

FIG. 1 is a schematic top view of a biochemical reaction apparatus as a first embodiment according to the present invention.

FIG. 2 is a schematic side view of the biochemical reaction apparatus as the first embodiment according to the present invention.

FIG. 3 is a schematic sectional view taken in the line 3-3 of FIG. 2.

FIG. 4 is a schematic sectional view taken in the line A-A of FIG. 1.

FIG. 5 is a schematic sectional view taken in the line A-A of FIG. 1 when a container is provided within a carriage.

FIG. 6 is a schematic sectional view taken in the line A-A of FIG. 1 when a cover is closed.

FIG. 7 is a schematic schematic sectional view taken in the line A-A of FIG. 1 when the carriage is in a process of being moved from a refrigeration part to a reaction part.

FIG. 8 is a schematic sectional view taken in the line A-A of FIG. 1 after the carriage is moved to the reaction part.

FIG. 9 is a schematic sectional view of a main part of a biochemical reaction apparatus as a second embodiment according to the present invention.

FIG. 10 is a schematic sectional view of the main part shown in FIG. 9 when a carriage is in a process of being moved from a refrigeration part to a reaction part.

FIG. 11 is a schematic sectional view of the main part shown in FIG. 9 after the carriage is moved to the reaction part.

FIG. 12 is a schematic sectional view of a main part of a biochemical reaction apparatus as a third embodiment according to the present invention.

FIG. 13 is a schematic sectional view of the main part shown in FIG. 12 when a carriage is in a process of being moved from a refrigeration part to a reaction part.

FIG. 14 is a schematic sectional view of the main part shown in FIG. 12 after the carriage is moved to the reaction part.

### DESCRIPTION OF THE EMBODIMENTS

The embodiments according to the present invention will be now described in the following.

### First Embodiment

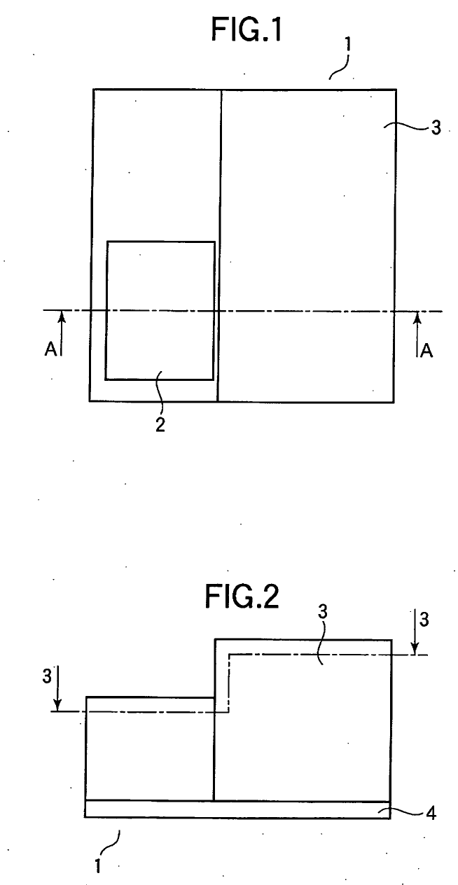

The first embodiment according to the present invention will be described in the following with reference to FIGS. 1 to 8.

FIG. 1 is a schematic top view of a biochemical reaction apparatus according to the present invention. A biochemical reaction apparatus 1 is covered by a case 3, and is provided with a cover 2 which is opened and closed by rotation of the cover.

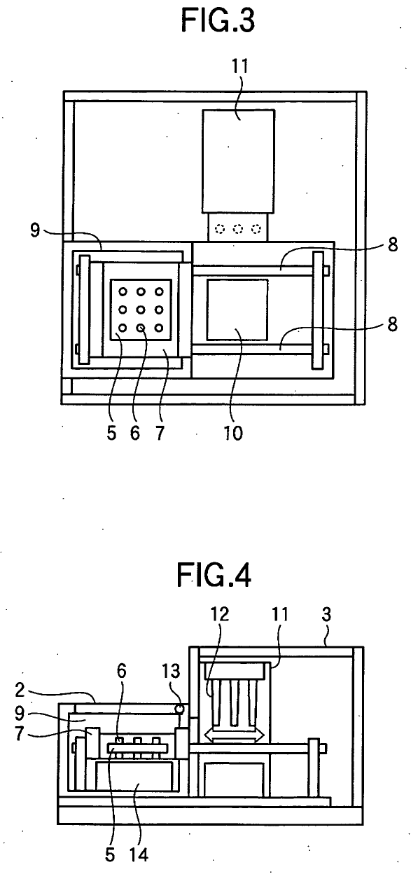

FIG. 2 is a schematic side view of the biochemical reaction apparatus while FIG. 3 is a schematic sectional view taken in the line 3-3 of FIG. 2. The biochemical reaction apparatus 1 housed in the case 3 has a refrigeration part 9 for storing a sample (such as a nucleic acid) and a reagent (such as a primer or a PCR enzyme) in reagent injection parts 6, a dispensing part 11 for injecting the reagent into the reagent injection parts 6, and a reaction part (i.e., heating part) 10 for agitation, heating and the like of the reagent in a container 5. Exemplary processing in the reaction part includes PCR amplification.

In FIG. 3, the container 5 is mounted on a carriage 7. The container 5 has nine reagent injection parts 6 provided therein. In FIG. 3, the carriage 7 is located in the refrigeration part 9.

The carriage 7 is supported by a drive shaft 27 (not shown) and rails 8. A guide for the drive shaft 27 is formed on the carriage 7. A motor 26 (not shown) as driving means is coupled to the drive shaft 27. The motor 26 is driven to rotate the drive shaft 27, thereby moving the carriage 7 along the rails 8 between the refrigeration part 9 and the reaction part 10.

A dispensing part 11 is provided for moving and agitating the reagent in the reagent injection parts 6. Pipette chips 12 are attached to the dispensing part 11.

FIG. 4 is a schematic sectional view taken in the line A-A of FIG. 1. In FIG. 4, the carriage 7 is located in the refrigeration part 9. A cooling part 14 is provided under the carriage 7. The cooling part 14 cools the inside of the refrigeration part 9, and the reagents in the reagent injection parts 6 are stored under a cooling condition. Further, by slightly moving the carriage 7 by the motor 26, air in the refrigeration part 9 is agitated by the carriage 7, and thus, it is possible to make uniform the temperature of air in the refrigeration part 9. In this embodiment, since the movable carriage 7 functions as an agitator, it is not necessary to additionally provide an agitator, and thus, the reaction apparatus can be simplified and costs can be reduced.

The cover 2 provided over the refrigeration part 9 is structured so as to open and close by rotation of the cover about a rotation shaft 13. More specifically, the cover 2 is structured such that the inside of the refrigeration part 9 is directly accessible from the outside of the case 3. Since this eliminates the necessity to expose the reaction part and the dispensing part to the outside when the reagent or the like is replaced, contamination due to the invading of liquid droplets, dusts or the like from outside the reaction apparatus can be reduced.

FIG. 5 is a schematic sectional view taken in the line A-A of FIG. 1 when the container 5 is mounted on the carriage 7. A user rotates the cover 2 about the rotation shaft 13 to open the cover 2, and then brings the container 5 onto the carriage 7 which is arranged in the refrigeration part 9. After the container 5 is mounted on the carriage 7, the cover 2 is rotated about the rotation shaft 13 to close the cover 2. In other words, this embodiment is structured such that the space inside the reaction apparatus is isolated from the space outside the reaction apparatus by the case 3 except for the container transporting part. Further, by providing the cover 2, communication between the outside of the reaction apparatus and the inside of the reaction apparatus can be structured at a minimum. Therefore, contamination due to the invading of liquid droplets, dusts or the like from the outside of the reaction apparatus can be reduced. Since the refrigeration part 9 is provided on a front side facing a user when the biochemical reaction apparatus 1 is used (i.e., the left side of the biochemical reaction apparatus 1 in FIGS. 1 to 8 is the front side facing a user), the operability of the reaction apparatus is improved. More specifically, a user can clearly recognize where the container 5 is to be located, and the container 5 can be easily brought into and out of the reaction apparatus by opening the cover 2 of the refrigeration part 9.

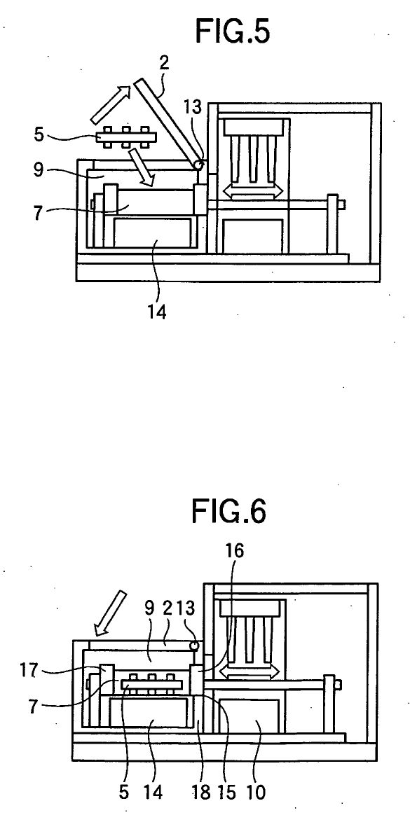

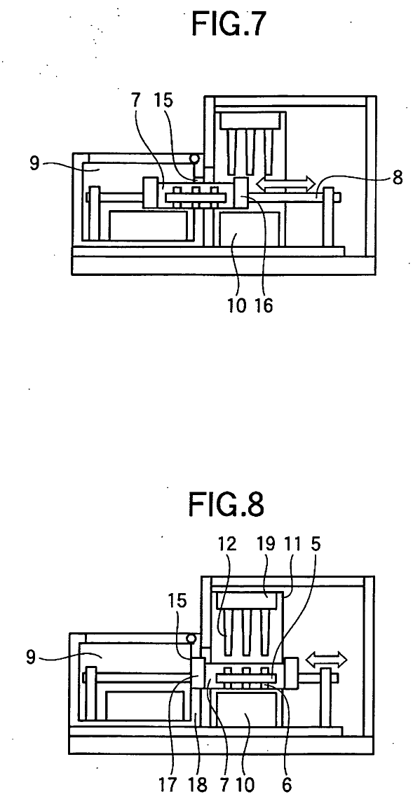

FIG. 6 is a schematic sectional view taken in the line A-A of FIG. 1 when the cover 2 is closed by rotation of the cover after the container 5 is provided within the carriage 7. FIG. 7 is a schematic sectional view taken in the line A-A of FIG. 1 when the carriage 7 is in the process of being moved from the refrigeration part 9 to the reaction part (i.e., heating part) 10. FIG. 8 is a sectional view taken along the line A-A in FIG. 1 after the carriage 7 is moved to a position above the reaction part (i.e., heating part) 10.

A refrigeration part case 18 houses the cooling part 14, has the cover 2 provided on an upper surface thereof, and has an opening 15 on the side of the reaction part (i.e., heating part) 10. The carriage 7 is moved between the side of the refrigeration part 9 and the reaction part (i.e., heating part) 10 through the opening 15 (see FIG. 7).

Hermetic seal parts 16 and 17 for sealing the opening 15 are provided at respective ends of the carriage 7. The hermetic seal part 16 seals the opening 15 when the carriage 7 is located in the refrigeration part 9 (see FIG. 6) while the hermetic seal part 17 seals the opening 15 when the carriage 7 is located above the reaction part (i.e., heating part) 10 (see FIG. 8). In this way, the simple structure of sealing the opening 15 by the movement of the carriage 7 makes it possible to hermetically seal the refrigeration part 9 and keep the inside of the refrigeration part under a cooling condition, whereby the cost of the reaction apparatus can be reduced.

When the carriage 7 is located above the reaction part (i.e., heating part) 10, a pipette chip attachment part 19 is moved to a position above the reagent injection parts 6 by a mechanism (not shown) provided in the dispensing part 11. The pipette chips 12 are moved to a position above the reagent injection parts 6 and raised/lowered by a mechanism (not shown) to move the reagent and to agitate the reagent.

As described above, according to this embodiment, as a result of providing in the container transporting part the cover which can be opened and closed and providing the case for isolating the space inside the reaction apparatus from the space outside the reaction apparatus, a part for communication between the outside of the reaction apparatus and the inside of the reaction apparatus can be structured at a minimum, and thus, contamination due to the invading of liquid droplets, dusts or the like from outside the reaction apparatus can be reduced. Further, since a user can clearly recognize where the container is to be located, the operability of the reaction apparatus is improved.

### Second Embodiment

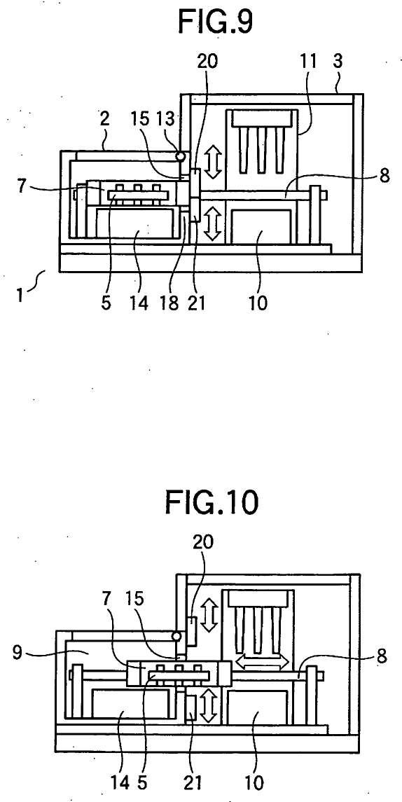

A second embodiment according to the present invention will be described in the following with reference to FIGS. 9 to 11. The basic structure of this embodiment is the same as that of the first embodiment except for the structure of the hermetic seal parts provided on the carriage of the first embodiment. Thus, description of the same parts will be omitted. The same structural elements as those in the first embodiment are denoted by the same reference numerals.

FIG. 9 is a schematic sectional view of a main part of the second embodiment according to the present invention.

A wall of the refrigeration part case 18, which is a partition between the side of the refrigeration part 9 and the side of the reaction part (i.e., heating part) 10, has an opening 15 formed therein. The refrigeration part case 18 of this embodiment is provided with an upper shutter 20 and a lower shutter 21 for sealing the opening 15. In FIG. 9, the upper and lower shutters 20 and 21 are moved to seal the opening 15.

The upper and lower shutters 20 and 21 are moved vertically as indicated by arrows in FIG. 9 by a mechanism (not shown). The shutters 20 and 21 may be structured so as to open and close based on a signal outputted from a sensor (not shown) for detecting the carriage 7. Also, the upper and lower shutters 20 and 21 may be structured so as to open and close by being pushed by the carriage 7. In this case, the structure may be as described in the following. Tapered members are attached to front and rear surfaces of the carriage 7. By moving the carriage 7 in a direction toward the opening 15, the tapered members force into a juncture between the upper and lower shutters 20 and 21 to force the shutters away from each other. The shutters which are forced away from each other are adapted to be closed by an urging member (not shown) such as a spring, after the carriage 7 passes through the opening 15. The upper and lower shutters 20 and 21 may also be structured so as to open and close not by vertical sliding but by falling down in the direction of movement of the carriage 7. In this case, the upper and lower shutters 20 and 21 are opened by being pushed by the carriage 7 without the above-described tapered members attached to the carriage 7. The shutters which are opened by being pushed are structured so as to close by an urging member (not shown) after the carriage 7 passes through the opening 15. In this way, the simple structure of opening and closing the shutters makes it possible to realize hermetic seal of the refrigeration part 9 and keep the inside of the refrigeration part 9 at a cooling condition, whereby the cost of the reaction apparatus can be reduced.

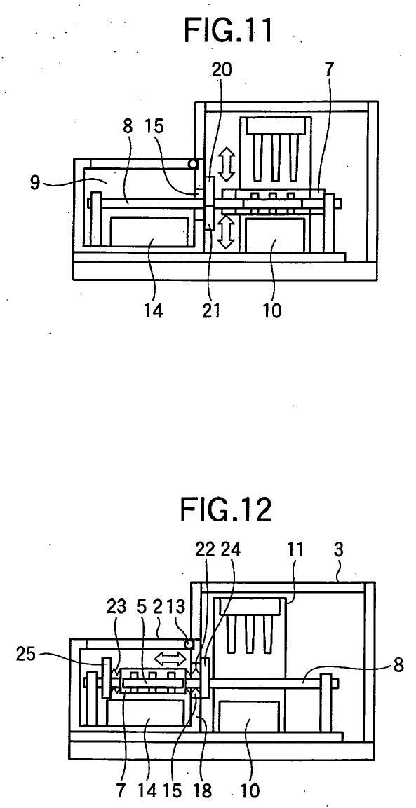

FIG. 10 shows a state where the upper shutter 20 is moved up and the lower shutter 21 is moved down. By moving the upper and lower shutters 20 and 21, the carriage 7 can pass through the opening 15. In FIG. 10, the carriage 7 is in the process of being moved from the refrigeration part 9 toward the reaction part (i.e., heating part) 10. FIG. 11 shows a state where the carriage 7 has been moved to a position above the reaction part (i.e., heating part) 10. The upper shutter 20 is moved down while the lower shutter 21 is moved up to seal the opening 15. Therefore, the refrigeration part 9 is hermetically sealed such that air cooled in the refrigeration part 9 does not flow out of the refrigeration part 9.

### Third Embodiment

A third embodiment according to the present invention will be described in the following with reference to FIGS. 12 to 14. The basic structure of this embodiment is the same as those of the first and second embodiments except for the method of hermetically sealing the opening in the refrigeration part. Thus, description of similar parts will be omitted. The same structural elements as those in the first and second embodiments are denoted the same reference numerals.

FIG. 12 is a schematic sectional view of a main part of the third embodiment according to the present invention.

A hermetic seal cover 24 is attached via an extendable member 22 to the carriage 7 on the side of the reaction part (i.e., heating part) 10 (i.e., right side of the carriage 7 in FIG. 12). Another hermetic seal cover 25 is attached via an extendable member 23 to the carriage 7 on the left side of the refrigeration part 9 (i.e., left side of the carriage 7 in FIG. 12).

As shown in FIG. 12, when the carriage 7 is located in the refrigeration part 9, the hermetic seal cover 24 is urged in the left direction in the figure by the extendable member 22 to be brought into intimate contact with the refrigeration part case 18, and thus, the opening 15 is hermetically sealed.

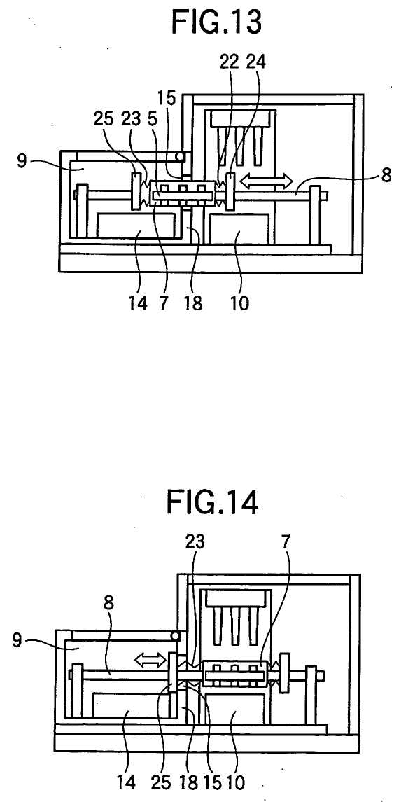

FIG. 13 shows a state where the carriage 7 is in the process of being moved from the refrigeration part 9 toward the reaction part (i.e., heating part) 10. Movement of the carriage 7 from the refrigeration part 9 toward the reaction part (i.e., heating part) 10 moves the extendable member 22 and the hermetic seal cover 24 together with the carriage 7. This gradually weakens the contact force between the hermetic seal cover 24 and the refrigeration part case 18 which is exerted by urging the hermetic seal cover 24 toward the refrigeration part case 18 with the extendable member 22. When the carriage 7 moves a predetermined distance, the contact between the refrigeration part case 18 and the hermetic seal cover 24 is completely released, and the opening 15 which has been sealed by the hermetic seal cover 24 is opened.

FIG. 14 shows a state where the carriage 7 has been moved to a position above the reaction part (i.e., heating part) 10. The hermetic seal cover 25 is coupled to the carriage 7 via the extendable member 23. The hermetic seal cover 25 is urged in the right direction in the figure by the extendable member 23 to be brought into intimate contact with the refrigeration part case 18, and thus, the opening 15 is hermetically sealed and the refrigeration part 9 is hermetically sealed such that air cooled in the refrigeration part 9 does not flow out of the refrigeration part 9.

In this embodiment, since the hermetic seal covers 24 and 25 are urged by the extendable members 22 and 23, respectively, to be brought into intimate contact with the refrigeration part case 18, the opening 15 can be hermetically sealed to obtain a high hermetic property.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-280096, filed Sep. 27, 2005, which is hereby incorporated by reference herein in its entirety.

What is claimed is:

1. A biochemical reaction apparatus comprising:
a reaction part;
a refrigeration part for refrigerating a liquid supplied to the reaction part;
a case member for covering the reaction part and the refrigeration part; and
a transporting part for allowing a direct access from an outside of the case member to an inside of the refrigeration part.

2. A biochemical reaction apparatus according to claim 1, wherein the transporting part comprises a cover which can be opened and closed.

3. A biochemical reaction apparatus according to claim 1, wherein the refrigeration part comprises a refrigeration part case member for partitioning a space formed by the reaction part and a space formed by the refrigeration part in the case member.

4. A biochemical reaction apparatus according to claim 3, further comprising a carriage and a transfer mechanism for transferring the liquid in the refrigeration part to the reaction part.

5. A biochemical reaction apparatus according to claim 4, wherein the refrigeration part case member comprises an opening through which a body of the carriage can pass, and the biochemical reaction apparatus further comprises a hermetic seal part for hermetically sealing the opening.

6. A biochemical reaction apparatus according to claim 5, wherein the hermetic seal part is mounted on to the carriage.

7. A biochemical reaction apparatus according to claim 1, wherein the transporting part is provided on a front side of the biochemical reaction apparatus when the apparatus is used.

8. A biochemical reaction apparatus comprising:
a reaction part;
a refrigeration part for refrigerating a liquid supplied to the reaction part;
a case member for covering the reaction part and the refrigeration part;
a carriage for transporting the liquid in the refrigeration part to the reaction part;
a transporting mechanism for transportring the carriage;
a refrigeration part case member for partitioning a space formed by the reaction part and a space formed by the refrigeration part in the case member;
an opening formed in the refrigeration part case member through which a body of the carriage can pass; and
a hermetic seal part provided on the carriage for hermetically sealing the opening.

9. A biochemical reaction apparatus according to claim 8, wherein the hermetic seal part is formed at an end of the carriage.

10. A biochemical reaction apparatus according to claim 8, wherein the hermetic seal part is attached to each of a front side and a rear side of the carriage through an extendable member, respectively, and the opening is hermetically sealed by bringing the hermetic seal part into intimate contact with a wall forming the opening around the opening by an urging force exerted by the extendable member.

11. A biochemical reaction apparatus according to claim 8, wherein the reaction apparatus further comprises a shutter for opening and closing the opening.

12. A biochemical reaction apparatus according to claim 4, wherein the carriage also functions as an agitator for agitating air in the refrigeration part by moving.

13. A biochemical reaction apparatus according to claim 8, wherein the carriage also functions as an agitator for agitating air in the refrigeration part by moving.
